(19) United States
(12) Patent Application Publication
(10) Pub. No.: US 2007/0163937 A1
(43) Pub. Date: Jul. 19, 2007

(54) Oil strainer and method of manufacturing the same

(76) Inventor: Taisuke Sato, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/652,093

(22) Filed: Jan. 11, 2007

(30) Foreign Application Priority Data
Jan. 19, 2006 (JP) 2006-011512

(51) Int. Cl. B01D 35/02

(52) U.S. Cl. 210/232; 210/435; 210/451

(57) ABSTRACT

There is provided an oil strainer in which the filtration area is large, and which can go around an obstacle between pipes etc. to be connected. An oil strainer 1 includes a housing 2 in which an open portion 6 of a case body 3 is closed by a cover body 20, a filter element 30 disposed in the housing 2, an inflow portion 15, and an outflow portion 16. The housing 2 is formed so as to extend along one axis direction in a state of providing a bend portion in an intermediate portion in one axis direction X, and the inflow portion 15 and the outflow portion 16 are arranged at both ends in one axis direction X.

### BACKGROUND OF THE INVENTION

1. Field of the Invention

The present invention relates to an oil strainer that is used for vehicles and industrial machinery to filter oil and to a method of manufacturing the same.

2. Description of the Related Art

An oil strainer is generally made up of a housing for allowing oil to flow therein and a filter element disposed in the housing. An oil strainer of a type in which the housing is formed of a resin material is widely known. In the case where the housing is formed of a resin material, the oil strainer is completed mainly by molding a plurality of components in advance and by setting a filter element between these components and welding the components to each other.

Patent Document 1 discloses one example of the conventional oil strainer. In this oil strainer, a pipe-form housing is formed by two resin-made components. At both ends in the axial direction of the housing, an inflow portion for allowing oil to be filtered to flow and an outflow portion for discharging the oil having been filtered are provided. A filter element is inserted through the inflow portion and is arranged in the housing, and the filter element is arranged so as to be held between the components.

Further, Patent Document 1 discloses an oil strainer in which the filter element and one component are formed as one member. In this oil strainer, the housing includes a tubular component formed with an open portion and a flat plate shaped component that closes the open portion. The filter element is provided on the inner surface of the flat plate shaped component so as to be at right angles to the flat plate shaped component, and the filter element and the flat plate shaped component are formed as one member.

In this oil strainer, on the inner surface of the tubular component, a locking portion for locking the tip end portion of the filter element is formed at a position facing to the open portion, and when both of the components are welded to each other, the tip end of the filter element is locked by the locking portion.

[Patent Document 1] Japanese Patent Laid-Open No. 8-121138

However, a portion in which the oil strainer is mounted sometimes hinders the mounting of oil strainer because, for example, various pieces of equipment etc. are present around the portion and these pieces of equipment etc. interfere with the oil strainer. Patent Document 1 discloses only the oil strainer in which the housing thereof is merely formed slenderly in a straight line form, and consideration is not given specially to the conditions around the portion in which the oil strainer is mounted.

Therefore, if an obstacle is present between pipes or pieces of equipment to be connected to each other via the oil strainer, the installation itself of the oil strainer is sometimes impossible. To avoid such a disadvantage, the change of the positions themselves of the pipes to be connected can be thought of. However, in the present situation in which the standardization of parts progresses, the use of dedicated pipes is almost impossible.

### SUMMARY OF THE INVENTION

Accordingly, an object of the present invention is to provide an oil strainer which can be installed surely even in the case where an obstacle is present between pipes etc. to be connected to each other via the oil strainer, and moreover in which a simplified construction of the oil strainer itself is maintained so that the assembling work can be performed very easily, and moreover high quality can be ensured.

To achieve the above object, firstly, the present invention provides an oil strainer (1, 100) including a housing (2, 101) which is formed by a case body (3, 102) formed with an open portion (6, 105) and a cover body (20, 50, 120) which closes the open portion (6, 105) and allows oil to flow therein; a filter element (30, 60, 130) disposed in the housing (2, 101) to filter oil flowing in the housing (2, 101); and an inflow portion (15, 115) through which oil flows into the housing (2, 101) and an outflow portion (16, 116) through which the oil having flown in the housing (2, 101) flows out, wherein the housing (2, 101) is formed so as to extend along one axis direction (X), and the inflow portion (15, 115) is arranged on a first end side in one axis direction (X) and the outflow portion (16, 116) is arranged on a second end side in one axis direction (X); the filter element (30, 60, 130) is arranged so as to extend along one axis direction (X), and divides the interior of the housing (2, 101) into the dirty side (D) which is connected to the inflow portion (15, 115) and the clean side (C) which is connected to the outflow portion (16, 116); and the housing (2, 101) is formed with a bend portion (18, 22), (53), (110) in an intermediate portion in one axis direction (X), and the filter element (30, 60, 130) is formed with an element bend portion (34, 64, 111) bent in the same direction as the bend portion (18, 22), (53), (110) of the housing (2, 101) at the position corresponding to the bend portion (18, 22), (53), (110) of the housing (2, 101) regarding one axis direction (X)

Also, the present invention may be configured so that in the above-described oil strainer (1, 100), in the case body (3, 102), there is provided a groove portion (8, 107) including a guide portion (9, 108) for guiding the filter element (30, 60, 130) to the inside of the case body (3, 102) by inserting both side edges in one axis direction (X) of the filter element (30, 60, 130) into the inside and a locking portion (10, 109) for locking the filter element (30, 60, 130) having been guided by the guide portion (9, 108) by inserting the tip end edge in the insertion direction of the filter element (30, 60, 130) into the inside; the groove portion (8, 107) is formed along the inner peripheral surface of the case body (3, 102) so as to connect two different places of a peripheral edge portion (6a, 105a) of the open portion (6, 105), and divides the interior of the case body (3, 102) into the dirty side (D) on which the inflow portion (15, 115) is disposed and the clean side (C) on which the outflow portion (16, 116) is disposed; and the peripheral edge of the filter element (30, 60, 130) is locked in the housing (2, 101) by the groove portion (8, 107).

Further, the entire periphery of the peripheral edge portion (6a, 105a) of the open portion (6, 105) formed on the case body (3, 102) is formed in a state of being closed in the peripheral direction by making a member forming the case body (3, 102) continuous.

Secondly, to achieve the above object, the present invention provides manufacturing methods described below.

A first manufacturing method includes a case forming step for forming a case body (3, 102) which is formed with an open portion (6, 105) and extends in one axis direction (X); a cover body molding step for molding a cover body (20, 120), with which a filter element (30, 130) is integrated, by injection molding so that the cover body (20, 120) for closing the open portion (6, 105) and the filter element (30, 130), which is perpendicular to the cover body (20, 120) from one surface side of the cover body (20, 120) and consists of a mesh portion (31) and a frame portion (32), are formed as one member; a setting step for closing the open portion (6, 105) by the cover body (20, 120) by inserting the filter element (30, 130) from the open portion (6, 105) so that the lengthwise direction of the filter element (30, 130) coincides with one axis direction (X) in which the case body (3, 102) extends, and a welding step for welding the peripheral edges of the case body (3, 102) and the cover body (20, 120) to each other, wherein in the cover body molding step, a mold which is formed so as to be separated in an intermediate portion in the thickness direction of a cavity (44) for forming the filter element (30, 130) is used; the cavity (44) is formed with a bend portion (44a), which molds the cover body (20, 120) and the filter element (30, 130) by bending the same in the thickness direction thereof, in an intermediate portion in the lengthwise direction of the filter element (30, 130); in a portion for forming the mesh portion (31) of the cavity (44), a plurality of mesh hole forming protrusions (45) for forming mesh holes (31a) forming the mesh portion (31) are formed in parallel with each other toward a first mold in a cavity surface of a second mold; and after a resin material has been injected into the cavity (44), the second mold in which the mesh hole forming protrusions (45) are formed and the first mold are separated from each other in the direction in which the mesh hole forming protrusions (45) extend to form the filter element (30, 60, 130).

A second manufacturing method includes a case forming step for forming a case body (3, 102) which is formed with an open portion (6, 105) and extends in one axis direction (X); a cover body forming step for forming a cover body (50) which closes the open portion (6, 105) and extends in one axis direction (X); a filter element molding step for molding a filter element (60), consisting of a mesh portion (61) and a frame portion (62), as one member by injection molding of one step using a resin material; a filter element setting step for inserting the filter element (60) into the case body (3, 102) through the open portion (6, 105) so that the lengthwise direction of the filter element (60) coincides with the one axis direction (X) in which the case body (3, 102) extends; and a welding step for welding the peripheral edges of the case body (3, 102) and the cover body (50) to each other after the cover body (50) is put on the open portion (6, 105) of the case body (3, 102) to close the open portion (6, 105), wherein in the filter element molding step, a mold which is formed so as to be separated in an intermediate portion in the thickness direction of a cavity for forming the filter element (60) is used; the cavity is formed with a bend portion, which molds the filter element (60) by bending the same in the thickness direction thereof, in an intermediate portion in the lengthwise direction of the filter element (60); in a portion for forming the mesh portion (61) of the cavity, a plurality of mesh hole forming protrusions for forming mesh holes (61a) in the mesh portion (61) are formed in parallel with each other toward a first mold in the cavity surface of a second mold; and after the resin material has been injected into the cavity, the second mold in which the mesh hole forming protrusions are formed and the first mold are separated from each other in the direction in which the mesh hole forming protrusions extend to form the filter element (60).

In the oil strainer in accordance with the present invention, firstly, since the filter element is arranged along one axis direction in which the housing extends, the clearance between the housing and the filter element can be made constant over the total length. Therefore, in the region in which the filter element is arranged, there is no portion in which the flow path is narrowed, so that the rise in pressure and the occurrence of zigzag flow of oil can be prevented effectively, whereby filtration can be accomplished efficiently.

Secondly, since the bend portion is formed in the intermediate portion in one axis direction, even if an obstacle is present between pipes etc. to be connected via the oil strainer, the oil strainer can be arranged by going around the obstacle.

Also, in the manufacturing method for the oil strainer in accordance with the present invention, the filter element consisting of the mesh portion and the frame portion surrounding the periphery of the mesh portion is molded by injection molding of one step, whereby the filter member is formed as one member. Therefore, the manufacturing efficiency can be improved. In particular, in forming the mesh holes forming the mesh portion, since the mold is released from the single direction, the filter element molding step can be carried out in a short period of time.

### BRIEF DESCRIPTION OF THE DRAWINGS

FIG. 1 is an exploded perspective view of an oil strainer in accordance with a first embodiment of the present invention;

FIG. 2 is a partially broken side view of the oil strainer shown in FIG. 1;

FIG. 3 is a plan view of the interior of the oil strainer shown in FIG. 1, viewed from an open portion of a case body;

FIG. 4 is a sectional view showing the outline of a mold for molding a cover body;

FIG. 5 is a perspective view showing mesh hole forming protrusions formed on the mold shown in FIG. 4;

FIG. 6 is an explanatory view showing the outline of a mold releasing process for a filter element;

FIG. 7 is an enlarged view showing one example of mesh holes forming a mesh portion;

FIG. 8 is a perspective view of a cover body and a filter element which are formed as separate members;

FIG. 9 is an explanatory view showing a state of oil flowing in the oil strainer shown in FIG. 1;

FIG. 10 is an explanatory view showing a state of oil flowing in an oil strainer using a plate-shaped filter element;

FIG. 11 is views showing various bend modes of a filter element and a groove portion; and

FIG. 12 is a plan view of an oil strainer in accordance with a second embodiment of the present invention.

### DETAILED DESCRIPTION OF THE PREFERRED EMBODIMENTS

Embodiments of the present invention will now be described with reference to the accompanying drawings.

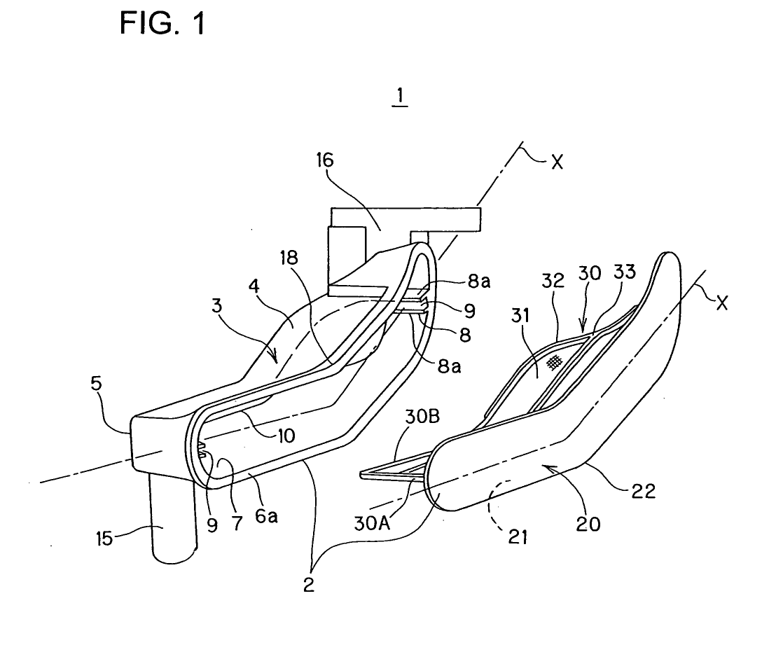

FIGS. 1 to 7 show an oil strainer in accordance with a first embodiment of the present invention.

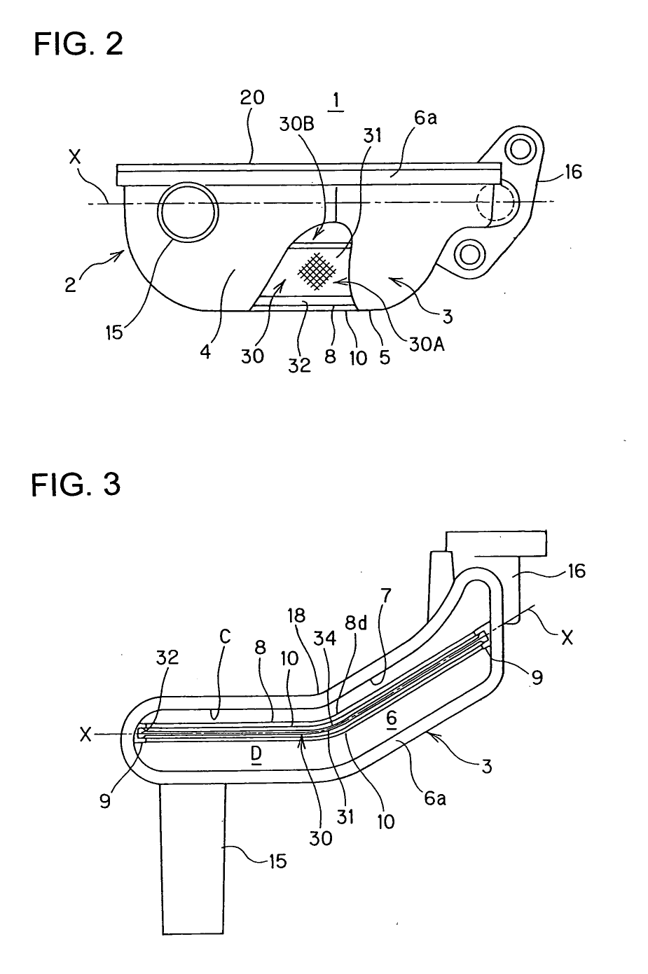

FIG. 1 is a perspective view showing a state in which a case body 3 and a cover body 20, which form an oil strainer 1, are separated from each other. FIG. 2 is a partially broken side view showing a state in which the case body 3 and the cover body 20 are welded to and integrated with each other. The oil strainer 1 includes a housing 2 that forms the outer shell of the oil strainer 1 and allows oil to flow therein and a filter element 30 disposed within the housing 2. The housing 2 is made up of a case body 3 and a cover body 20, each of which is formed of a resin material. The cover body 20 and the filter element 30 are formed as one member.

The case body 3 includes a side wall portion 4 and a bottom surface portion 5, and an open portion 6 is formed at the upper part of the case body 3. The case body 3 is formed slenderly so as to extend in one axis direction X, and is curved sideward with a bend portion 18 being formed in an intermediate portion in one axis direction X. The open portion 6 is formed so as to extend in one axis direction X corresponding to the shape of the case body 3. Also, on the first end side in one axis direction X of the case body 3, an inflow portion 15 through which oil flows in is provided, and on the other hand, on the second end side in one axis direction X thereof, an outflow portion 16 allowing the oil having passed through the housing 2 to flow out is provided.

On an inner surface 7 of the case body 3, a groove portion 8 is formed in the side wall portion 4 and the bottom surface portion 5. As shown in FIG. 3, the groove portion 8 is formed with a pair of groove walls 8a extending in parallel with each other so as to project from the inner surface 7 of the case body 3 toward the inside of the case body 3. The groove portion 8 is formed along one axis direction X so as to connect the first end side and the second end side in one axis direction X of a peripheral edge portion 6a of the open portion 6 to each other. The groove portion 8 also has a bend portion 8A, and is curved in this bend portion 8A so as to coincide with the degree of curving of the case body 3. The inflow portion 15 and the outflow portion 16 are provided at positions on the opposite side with the groove portion 8 being held therebetween, and divide the interior of the case body 3 into the dirty side D on which the inflow portion 15 is disposed and the clean side C on which the outflow portion 16 is disposed. Therefore; when the filter element 30 is placed in the housing 2, the interior of the case body 3 is divided into the dirty side D on which the inflow portion 15 is disposed and the clean side C on which the outflow portion 16 is disposed.

Also, the peripheral edge portion 6a of the open portion 6 formed in the upper part of the case body 3 is formed so as to be made continuous by a member forming the side wall portion 4 without a break throughout the entire periphery in a state of being closed in the peripheral direction. In order to make the peripheral edge portion 6a of the open portion 6 in the closed state in this manner, both of the inflow portion 15 and the outflow portion 16 are provided under the open portion 6 independently of the open portion 6. Therefore, the case body 3 has high rigidity and strength, so that deformation is less liable to occur.

On the other hand, as shown in FIG. 1, the cover body 20 is formed into a plate shape, and extends in one axis direction X. Also, the cover body 20 is formed with the filter element 30 integrally. The filter element 30 extends from an inner surface 21 of the cover body 20 perpendicularly to the cover body 20 in the center in the width direction of the cover body 20. The filter element 30 includes a mesh portion 31 that filters out impurities from oil, a frame portion 32 surrounding the periphery of the mesh portion 31, and a center rib 33 disposed at a substantially central position in the height direction. The shape of the frame portion 32 is formed individually so as to correspond to the shapes of the bottom surface portion 5 and the side wall portion 4 of the case body 3.

The cover body 20 and the filter element 30 also have bend portions 22 and 34, respectively, in an intermediate portion in one axis direction X, and are curved sideward at the positions of the bend portions 22 and 34, respectively. The bend portion 22 of the cover body 20 and the bend portion 34 of the filter element 30 are formed at positions corresponding to the bend portion 18 of the case body 3 with respect to one axis direction X.

The oil strainer 1 having the above-described construction is formed as described below.

First, the case body 3 is completed in advance by injection molding or the like. Also, the cover body 20 with which the filter element 30 is integrated is formed by injection molding.

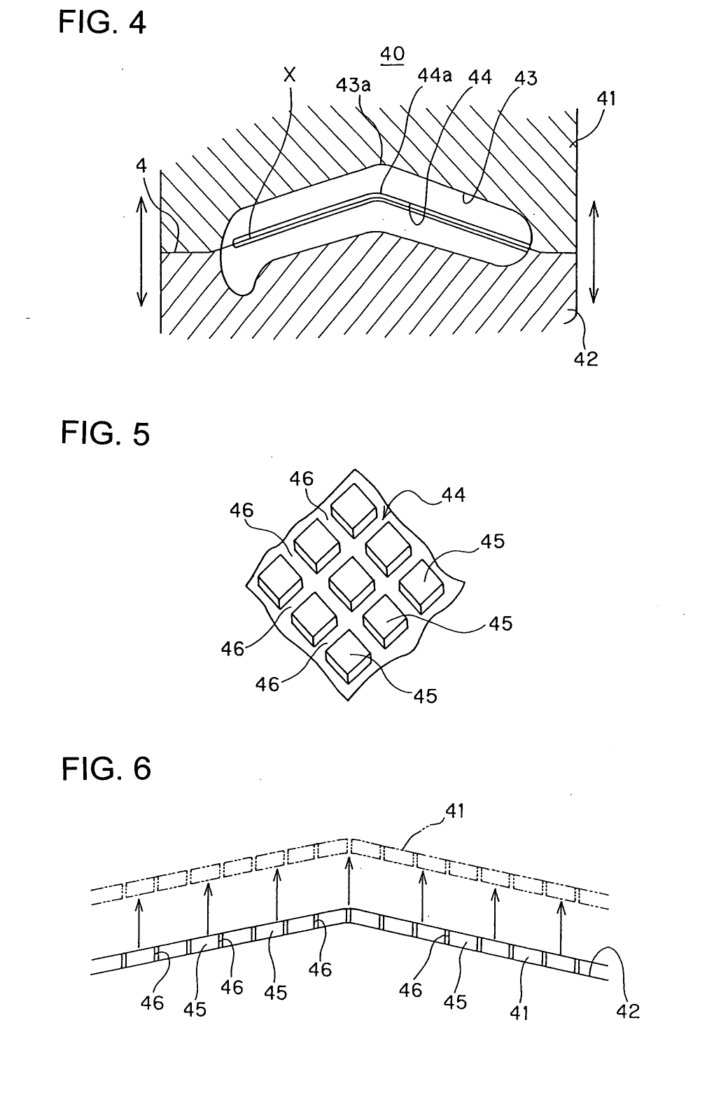

As shown in FIG. 4, a mold 40 used for injection molding is made up of an upper mold 41 and a lower mold 42. By joining these two molds 41 and 42 to each other, a cavity 43 for molding the plate-shaped cover body 20 and a cavity 44 for molding the filter element 30 are formed integrally in the mold 40.

The cavity 43 for molding the cover body 20 is formed so that the width direction of the cover body 20 coincides with the up and down direction of the mold 40. On the other hand, the cavity 44 for molding the filter element 30 is formed along one axis direction X perpendicularly to the cavity 43 in the center in the width direction of the cavity 43. In the cavity 44 for molding the filter element 30, portions for molding the mesh portion 31, the frame portion 32, and the center rib 33 are formed. In the cavities 43 and 44, bend portions 43a and 44a are formed, respectively, in an intermediate portion in one axis direction X to form the bend portions 22 and 34 on the cover body 3 and the filter element 30, respectively. A mold parting portion 47 between the upper mold 41 and the lower mold 42 is formed along one axis direction X at the position of the cavity 44.

In a portion of the cavity 44 for molding the mesh portion 31, as shown in FIGS. 5 and 6, a plurality of mesh hole forming protrusions 45 are formed. The external shape of each of the mesh hole forming protrusions 45 is formed into a cube, and space portions 46 arranged at fixed intervals are formed between the protrusions 45 adjacent to each other in the horizontal and vertical directions. Also, the mesh hole forming protrusions 45 project toward the lower mold 42 in parallel with each other.

According to this mold 40, when a resin material is injected in the cavities 43 and 44 in the state in which the upper mold 41 and the lower mold 42 are joined to each other, the cover body 20 is formed by the cavity 43, and the filter element 30 is formed by the cavity 44. At this time, in the cavity 44, the resin material is injected only in the space portions 46 formed between the mesh hole forming protrusions 45 in the portion forming the mesh portion 31.

Subsequently, as shown in FIG. 6, the upper mold 41 and the lower mold 42 are separated from each other in the direction in which the mesh hole forming protrusions 45 elongate, by which a molded product is released. Since the mesh hole forming protrusions 45 are parallel with each other, if the upper mold 41 and the lower mold 42 are moved in the direction in which the mesh hole forming protrusions 45 elongate, the molded product is released smoothly without being caught by the upper mold 41. Thereby, the product in which the filter element 30 and the cover body 20 are formed as one member can be completed by injection molding of one step.

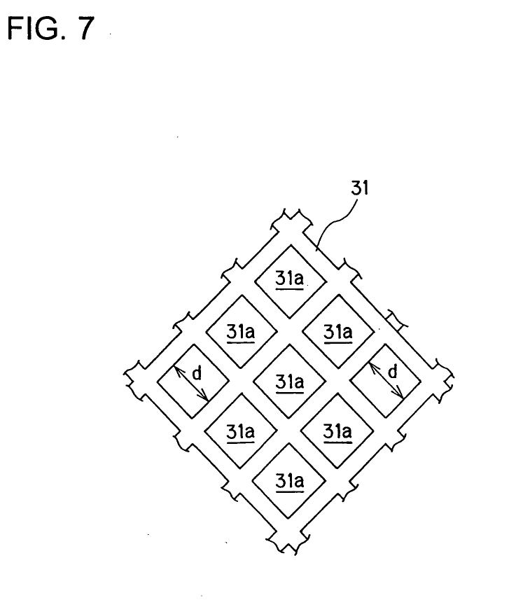

FIG. 7 shows a mode of the mesh portion 31 of the filter element 30 molded as described above. The mesh portion 31 shown in FIG. 7 is formed with a plurality of square-shaped mesh holes.

After the cover body 20 with which the filter element 30 is integrated has been completed, the filter element 30 is inserted through the opening portion 6, and the opening portion 6 of the case body 3 is closed by the cover body 20 to integrate both bodies with each other. At this time, the frame portion forming the peripheral edge of the filter element 30 is inserted in the inside of the groove portion 8 formed on the inner surface of the case body 3. At this time, the portion formed on the inner surface of the side wall portion 4 functions as a guide portion 9, so that the filter element 30 is inserted into the inside of the case body 3 along the guide portion 9. Also, after the filter element 30 has been inserted into the case body 3 completely, the frame portion 32 on the tip end side in the insertion direction is inserted in the inside of the groove portion formed in the bottom surface portion of the case body 3. This groove portion formed in the bottom surface portion functions as a locking portion 10 for locking the tip end side of the filter element 30.

After the cover body 20, in which the filter element 30 is inserted in the case body 3, and the case body 3 have been lapped on each other, the peripheral edge portion 6a of the case body 3 and the peripheral edge of the cover body 20 are welded to each other. As the welding method, the ultrasonic welding process is preferably used.

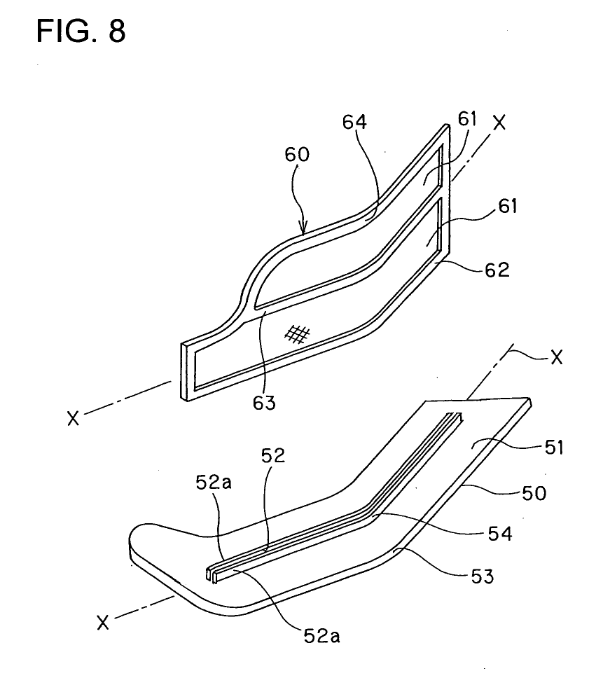

If a gap is formed between the groove portion 8 of the case body 3 and the frame portion 32 of the filter element 30, in the groove portion 8 in the side wall portion 4, the filter element 30 can be moved therein smoothly. Also, this gap functions as a relief for prevent the filter element 30 from being restrained than needed. The gap is formed so as to be smaller than the minimum dimension d (refer to FIG. 8) of a mesh hole 31a to prevent impurities from passing through.

By using the above-described oil strainer 1, even if any obstacle is present between the pipes or pieces of equipment which are to be connected via the oil strainer 1, the bend portions 18, 22 and 34 go around the obstacle. Therefore, the oil strainer 1 can be prevented from interfering with the obstacle.

As shown in FIG. 8, a cover body 50 and a filter element 60 may be provided as separate members.

The cover body 50 is formed in a plate shape extending in one axis direction X, and a bend portion 53 curving sideward is provided at an intermediate position in one axis direction X. Also, on the inner surface 51 side forming one surface side of the cover body 50, a groove portion 52 is formed in the center in the width direction of the cover body 50. This groove portion 52 extends along one axis direction X, and is formed so as to connect both end portions in one axis direction X of the cover body 50 to each other. The groove portion 52 is also formed with a pair of opposed groove walls 52a that are parallel with each other. The groove portion 52 is also formed with a bend portion 54 regarding one axis direction X at a position corresponding to the bend portion 53 of the cover body 50.

On the other hand, the filter element 60 includes a mesh portion 61 consisting of a plurality of mesh holes 61a, a frame portion 62 surrounding the periphery of the mesh portion 61, and a center rib 63 extending in one axis direction at a substantially central position in the height direction. In an intermediate portion in one axis direction X, a bend portion 64 that curves the filter element 60 sideward is formed.

Even in the case where the cover body 50 and the filter element 60 are formed as separate members in this manner, as in the case where the cover body and the filter element are formed as one member, the element portion is molded by injection molding, and the filter element 60 is completed through a process for forming mesh holes by mold release. The cover body 50 is also formed by injection molding etc.

In the assembling process, first, the filter element 60 is set in the case body 3. At this time, both ends in one axis direction X of the filter element 60 are inserted while the filter element 60 is guided by the groove portion 8. Also, the frame portion 62 on the tip end side in the insertion direction is inserted in the groove portion 8 functions as the locking portion 10 formed in the bottom surface portion 5 of the case body 3, by which the filter element 60 is locked to the case body 3.

Then, the open portion 6 formed at the upper part of the case body 3 is closed by the cover body 50. At this time, the frame portion 62 of the filter element 60 is inserted in the inside of the groove portion 52. Subsequently, the peripheral edge of the cover body 50 and the peripheral edge portion 6a at the upper part of the case body 3 are welded to complete the oil strainer 1.

When the open portion 6 of the case body 3 is closed by the cover body 50, the groove portion 52 of the cover body 50 and the groove portion 8 of the case body 3 are formed continuously so that both ends in one axis direction X of the groove portion 52 and the upper ends of portions formed in the side wall portions 4 of the case groove portion 8 coincide with each other.

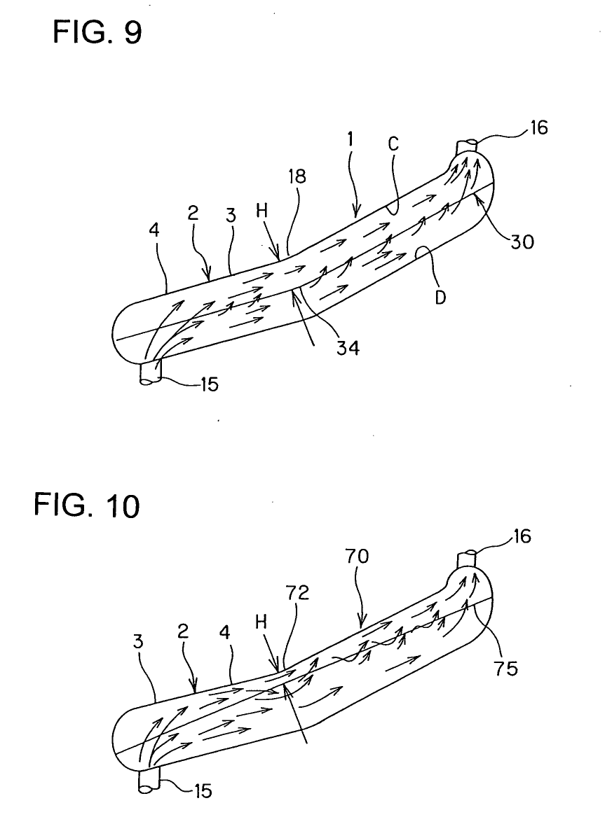

An advantage in the case where oil is filtered using the oil strainer having the above-described construction is explained with reference to FIGS. 9 and 10 by comparing with an oil strainer using a filter element formed merely into a flat plate shape.

FIG. 9 schematically shows the flow of oil when the oil is caused to flow in the oil strainer 1 in accordance with the first embodiment. In the oil strainer 1 in accordance with the first embodiment, since the filter element 30 is formed with the bend portion 34 at the position corresponding to the bend portion 18 of the housing 2, in the entire region in one axis direction X, the clearance H between the filter element 30 and side wall portion 5 of the case body 3 is kept approximately constant, so that oil flows smoothly. Also, since oil flows smoothly, the oil passes from the dirty side D to the clean side C uniformly in the entire region of the oil strainer.

On the other hand, FIG. 10 shows an oil strainer 70 in which a bend portion 72 is provided on the housing 2 only, and a filter element 75 is formed into a flat plate shape. The housing 2 of the oil strainer 70 is the same as the housing shown in FIG. 9. The flat plate shaped filter element 75 is locked to both ends in one axis direction X of the housing 2. In this case, on the clean side C, the clearance H between the filter element 75 and the side wall portion 4 of the case body 3 is narrowed significantly in the bend portion 18. Therefore, on the clean side C, the pressure increases unnecessarily at this position. Further, the oil that have passed through the filter element 75 on the front side of the bent portion 18 in one axis direction X and moved once to the clean side C flows backward to the dirty side D again. Moreover, the oil pulsates to the right and left due to the influence of the bend portion 72, so that a dead space that does not contribute to filtration is formed undesirably. Since these phenomena occur compositely, the filtration efficiency decreases significantly as compared with the oil strainer shown in FIG. 9, so that the smooth flow of oil is hindered.

Thus, the oil strainer in accordance with the first embodiment can filter oil efficiently. Also, since the filter element 30 is arranged in one axis direction X in which the housing 2 extends, the filtration area can be increased as compared with not only the case where the filter element 75 is arranged perpendicularly to one axis direction X but also the case where the filter element 75 is formed into a flat plate shape.

The positions in one axis direction X of the bend portions of the housing and the filter element are changed appropriately according to the surrounding circumstances, and the degree of curving thereof is changed appropriately according to the surrounding circumstances in which the oil strainer is installed.

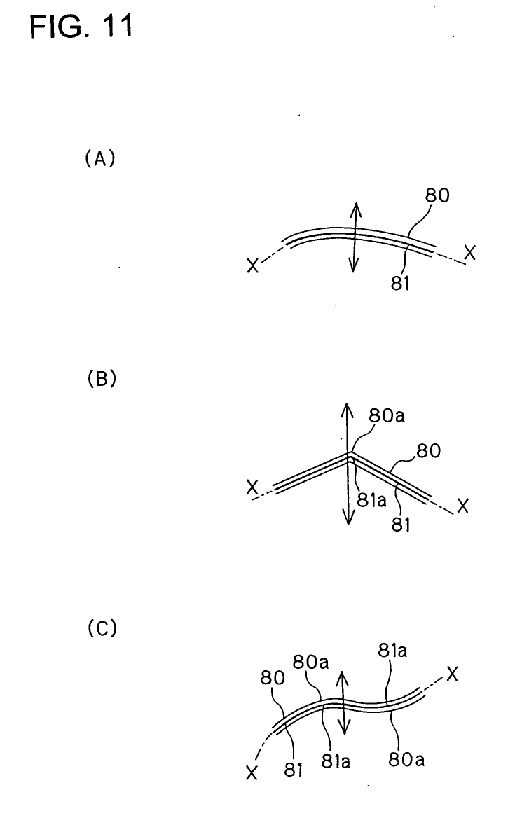

FIG. 11 shows the examples schematically. FIGS. 11 (A) to 11 (C) each shows a groove portion 80 and a filter element 81 disposed in the inside of the groove portion 80 in each mode. FIG. 11 (A) shows a mode in which the whole in one axis direction X curves greatly. The mode shown in FIG. 11 (B) is one in which bend portions 80a and 81a are formed so as be bent suddenly. The mode shown in FIG. 11 (C) is one in which the bend portions 80a and 81a are formed at two places in an intermediate portion in one axis direction. The arrow marks shown in FIGS. 11 (A) to 11 (C) indicate the direction in which the upper mold and the lower mold of the mold are separated from each other.

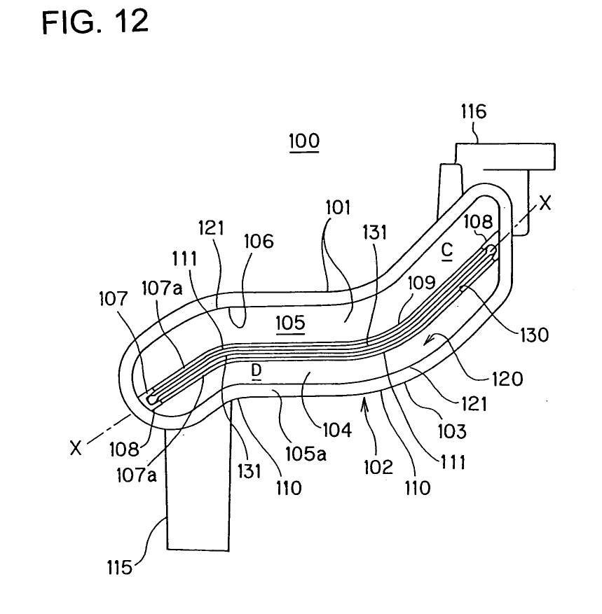

Herein, the oil strainer of the mode shown in FIG. 11 (C) is explained with reference to FIG. 12.

An oil strainer 100 shown in FIG. 12 includes a housing 101 that forms the outer shell of the oil strainer 100 and allows oil to flow therein and a filter element 130 disposed within the housing 101. The housing 101 is made up of a case body 102 and a cover body 120, each of which is formed of a resin material. In the strainer 100 shown in FIG. 12, the cover body 120 and the filter element 130 are formed as one member. In FIG. 12, the interior is also shown by a solid line for ease of understanding of the arrangement of the filter element 130 disposed in the housing 101.

The case body 102 includes a side wall portion 103 and a bottom surface portion 104, and an open portion 105 is formed at the upper part of the case body 102. The case body 102 is formed slenderly so as to extend in one axis direction X, and bend portions 110 are formed at two places in an intermediate portion in one axis direction X. These bend portions 110 are formed so as to curve the case body 102 in the opposite direction. The open portion 105 is formed so as to extend in one axis direction X corresponding to the shape of the case body 102. Also, on the first end side in one axis direction X of the case body 102, an inflow portion 115 is provided, and on the second end side thereof, an outflow portion 116 allowing the filtered oil to flow out is provided.

On an inner surface 106 of the case body 102, a groove portion 107 is formed in the side wall portion 103 and the bottom surface portion 104. The groove portion 107 is formed with a pair of groove walls 107a extending in parallel with each other so as to project from the inner surface 106 of the case body 102 toward the inside of the case body 102. The groove portion 107 is also formed along one axis direction X approximately in the center in the width direction of the case body 102, and connects the first end side and the second end side in one axis direction X of a peripheral edge portion 105a of the open portion 105 to each other. The groove portion 107 is also formed with bend portions 111 at two places corresponding to the bend portions 110 of the case body 102 so as to coincide with the degree of curving of the case body 102.

The inflow portion 115 and the outflow portion 116 are provided at positions on the opposite side to each other with the groove portion 107 formed on the inner surface 106 of the case body 102 being held therebetween, and the groove portion 107 divides the interior of the case body 102 into the dirty side D on which the inflow portion 115 is disposed and the clean side C on which the outflow portion 116 is disposed. Also, the peripheral edge portion 105a of the open portion 105 is closed continuously in the peripheral direction.

On the other hand, the cover body 120 is formed so as to extend in one axis direction X, and is formed with bend portions 121 at two places in the intermediate portion thereof. The bend portions 121 are provided at positions corresponding to the bend portions 110 of the case body 102, and are formed so as to curve the cover body 120 in the opposite direction.

The filter element 130 integrated with the cover body 120 includes a mesh portion that allows oil to pass through and filters out impurities contained in the oil, and a frame portion surrounding the periphery of the mesh portion, and is provided appropriately with a center rib to improve the rigidity. Also, the filter element 130 is also provided along one axis direction X, and is formed with bend portions 131 at two places in the intermediate portion in one axis direction X, namely, at the positions corresponding to the bend portions 110 of the case body and the bend portions 111 of the groove portion 107.

By providing such a construction, in the oil strainer 100 in accordance with the second embodiment as well, when the cover body 120 and the case body 102 are assembled to each other, the filter element 130 is arranged in the case body 102 in a state of being locked by the groove portion 107. Between the frame portion of the filter element 130 and the groove portion 107 formed on the case body 102, a gap smaller than the dimension of the maximum dimension portion of a mesh hole formed in the mesh portion is formed. The case body 102 and the cover body 120 can be welded to each other by the ultrasonic welding process. Also, in the oil strainer in accordance with this embodiment as well, the cover body and the filter element can be provided as separate members.

The oil strainer in which the filter element is arranged in the center in the width direction of the housing has been explained above as an example. However, the filter element may be arranged at a position shifting from the center if it is arranged in parallel with on axis direction in which the housing extends. Also, the groove portion need not necessarily be provided continuously. A break may be provided at an intermediate position of the groove portion, or the groove portion may be formed intermittently.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-011512 filed on Jan. 19, 2006 including the specification, claims, drawings and summary is incorporated herein by reference in its entirety.

1. An oil strainer comprising:
a housing which is formed by a case body formed with an open portion and a cover body which closes the open portion and allows oil to flow therein;
a filter element disposed in the housing to filter oil flowing in the housing; and
an inflow portion through which oil flows into the housing and an outflow portion through which the oil having flown in the housing flows out,
wherein the housing is formed so as to extend along one axis direction, and the inflow portion is arranged on a first end side in the one axis direction and the outflow portion is arranged on a second end side in the one axis direction;
the filter element is arranged so as to extend along the one axis direction, and divides an interior of the housing into a dirty side which is connected to the inflow portion and a clean side which is connected to the outflow portion; and
the housing is formed with a bend portion in an intermediate portion in the one axis direction, and the filter element is formed with an element bend portion bent in a same direction as the bend portion of the housing at a position corresponding to the bend portion of the housing regarding the one axis direction.

2. The oil strainer according to claim 1, wherein in the case body, there is provided a groove portion including a guide portion for guiding the filter element to an inside of the case body by inserting both side edges in the one axis direction of the filter element into an inside and a locking portion for locking the filter element having been guided by the guide portion by inserting a tip end edge in an insertion direction of the filter element into the inside;
the groove portion is formed along an inner peripheral surface of the case body so as to connect two different places of a peripheral edge portion of the open portion, and divides an interior of the case body into a dirty side on which the inflow portion is disposed and a clean side on which the outflow portion is disposed; and
a peripheral edge of the filter element is locked in the housing by the groove portion.

3. The oil strainer according to claim 1, wherein an entire periphery of the peripheral edge portion of the open portion formed on the case body is formed in a state of being closed in a peripheral direction by making a member forming the case body continuous.

4. A manufacturing method for an oil strainer, comprising:
a case forming step for forming a case body which is formed with an open portion and extends in one axis direction;
a cover body molding step for molding a cover body, with which a filter element is integrated, by injection molding so that the cover body for closing the open portion and the filter element, which is perpendicular to the cover body from one surface side of the cover body and consists of a mesh portion and a frame portion, are formed as one member;
a setting step for closing the open portion by the cover body by inserting the filter element from the open portion so that a lengthwise direction of the filter element coincides with the one axis direction in which the case body extends, and
a welding step for welding peripheral edges of the case body and the cover body to each other,
wherein in the cover body molding step, a mold which is formed so as to be separated in an intermediate portion in a thickness direction of a cavity for forming the filter element is used;
the cavity is formed with a bend portion, which molds the cover body and the filter element by bending the same in a thickness direction thereof, in an intermediate portion in the lengthwise direction of the filter element;
in a portion for forming the mesh portion of the cavity, a plurality of mesh hole forming protrusions for forming mesh holes forming the mesh portion are formed in parallel with each other toward a first mold in a cavity surface of a second mold; and
after a resin material has been injected into the cavity, the second mold in which the mesh hole forming protrusions are formed and the first mold are separated from each other in a direction in which the mesh hole forming protrusions extend to form the filter element.

5. A manufacturing method for an oil strainer, comprising:
a case forming step for forming a case body which is formed with an open portion and extends in one axis direction, and a cover body forming step for forming a cover body which closes the open portion and extends in the one axis direction;
a filter element molding step for molding a filter element, consisting of a mesh portion and a frame portion, as one member by injection molding of one step using a resin material;
a filter element setting step for inserting the filter element into the case body through the open portion so that a lengthwise direction of the filter element coincides with the one axis direction in which the case body extends; and
a welding step for welding peripheral edges of the case body and the cover body to each other after the cover body is put on the open portion of the case body to close the open portion,
wherein in the filter element molding step, a mold which is formed so as to be separated in an intermediate portion in a thickness direction of a cavity for forming the filter element is used;
the cavity is formed with a bend portion, which molds the filter element by bending the same in a thickness direction thereof, in an intermediate portion in the lengthwise direction of the filter element;
in a portion for forming the mesh portion of the cavity, a plurality of mesh hole forming protrusions for forming mesh holes in the mesh portion are formed in parallel with each other toward a first mold in a cavity surface of a second mold; and
after the resin material has been injected into the cavity, the second mold in which the mesh hole forming protrusions are formed and the first mold are separated from each other in a direction in which the mesh hole forming protrusions extend to form the filter element.

6. The oil strainer according to claim 2, wherein an entire periphery of the peripheral edge portion of the open portion formed on the case body is formed in a state of being closed in a peripheral direction by making a member forming the case body continuous.
